(19) United States
(12) Patent Application Publication
(10) Pub. No.: US 2013/0073398 A1
(43) Pub. Date: Mar. 21, 2013

(54) Self Service Platform for Building Engagement Advertisements

(71) Applicants: David Levy, West Hollywood, CA (US); Anthony Zanontian, Fresno, CA (US); Sejal Hingrajia, Santa Monica, CA (US); Aaron Stein, Los Angeles, CA (US); Joshua Rangsikitpho, Los Angeles, CA (US); Todd Tappin, Malibu, CA (US); Ed Davis, Los Angeles, CA (US)

(72) Inventors: David Levy, West Hollywood, CA (US); Anthony Zanontian, Fresno, CA (US); Sejal Hingrajia, Santa Monica, CA (US); Aaron Stein, Los Angeles, CA (US); Joshua Rangsikitpho, Los Angeles, CA (US); Todd Tappin, Malibu, CA (US); Ed Davis, Los Angeles, CA (US)

(21) Appl. No.: 13/236,311

(22) Filed: Sep. 19, 2011

(51) Int. Cl. G06Q 30/02

(52) U.S. Cl. 705/14.72

(57) ABSTRACT

The system and method for building an engagement advertisement disclosed herein includes enabling an advertiser to choose from multiple design templates and specify phases to create a rich, interactive advertisement. The engagement advertisement can be deployed onto the Internet, where a viewer can take part in an advertising experience based on the engagement advertisement. The advertising experience includes phases, and the viewer may be required to perform at least one action in a phase in order to advance to another phase. A completion to the advertising experience may be signified to the viewer, and in response to the completion to the advertising experience, the viewer may optionally be provided with a remuneration. The engagement advertisement may be used either as a stand-alone engagement advertisement or as part of a campaign, which includes targeting data, start/end dates, and a budget.

### TECHNICAL FIELD

The present embodiments generally relate to advertisements, particularly to building interactive engagement advertisements.

### BACKGROUND

Building an engagement online advertisement generally requires that an advertiser have extensive technical knowledge and tools. For example, building an engagement advertisement may require programming in multiple languages across various different toolsets. Conventional web content editors may provide simpler drag-and-drop techniques for building web pages and web sites, but cannot easily build a rich interactive advertising experience, provide sophisticated remuneration systems or track user responses to engagement advertisements, completion rates, and other engagement advertisement-related metrics.

### BRIEF DESCRIPTION OF THE FIGURES

FIG. 1 is a high-level block diagram of an advertising environment according to one embodiment.

FIG. 2 is a high-level block diagram illustrating a functional view of a typical computer system according to one embodiment.

FIG. 3 illustrates a flow diagram of a process executed by an interactive advertising system for facilitating building an engagement advertisement according to one embodiment.

FIG. 4 is a block diagram illustrating a detailed view of the self-service engagement advertising platform according to one embodiment.

FIG. 5 illustrates a flow diagram of a process executed by an interactive advertising system for presenting an engagement advertisement to a user according to one embodiment.

FIG. 6 is a screenshot illustrating a template gallery presented to an advertiser according to one embodiment.

FIG. 7 is a screenshot illustrating a prompt displayed to an advertiser to choose a level of engagement according to one embodiment.

FIG. 8 is a screenshot illustrating a Video template used by an advertiser to build a video engagement advertisement according to one embodiment.

FIG. 9 is a screenshot illustrating navigating to another screen in a template using thumbnails according to one embodiment.

FIG. 10 a screenshot illustrating navigating to another screen in a template using thumbnails according to one embodiment.

FIG. 11 is a screenshot illustrating a self-service engagement platform overview according to one embodiment.

FIG. 12 is a screenshot illustrating a campaign overview in the self-service engagement platform according to one embodiment.

FIG. 13 is a screenshot illustrating a prompt for modifying the parameters of a campaign according to one embodiment.

FIG. 14 is a screenshot illustrating drilling down into individual campaigns according to one embodiment.

FIG. 15 is a screenshot illustrating a prompt for sharing an engagement advertisement from within a campaign according to one embodiment.

FIG. 16 is a screenshot illustrating reports in the self-service engagement platform according to one embodiment.

FIG. 17 is a screenshot illustrating an example report according to one embodiment.

FIG. 18 is a screenshot illustrating various administrative tasks an advertiser can perform for engagement advertisements and campaigns.

### DETAILED DESCRIPTION OF EXAMPLE EMBODIMENTS

### Overview of Engagement Advertisements

A self-service engagement advertising platform described herein allows an advertiser or person working with an advertiser (jointly “advertiser”) to easily create rich and interactive engagement advertisements for deployment in online networks. An engagement advertisement is one in which a viewer (i.e., a user) is able to interact with the advertisement by providing one or more inputs (generally, “responses”), directly to the advertisement, responsive to the content of the advertisement, and where the advertiser pays for the advertisement only upon the user's interaction. By contrast, typical display advertisements (e.g., CPM ad) do not allow or require any response from the viewer, but rather have the viewer merely watch or observe the advertisement without any interaction with it.

Engagement advertisements may be presented in a number of different context and devices. Engagement advertisements may be presented on a webpage on website, within an application (“app”) or a game, in conjunction with a media product (e.g., prior to a video presentation, between presentations of songs, etc.), or any other online media or mechanism that enables the viewer to interact with the advertisement (and not merely observe it). The advertisements may be presented on any type of IP-enabled device, including smart phones, tablet computers, IP-enabled televisions and set-top receivers, and so forth. In one embodiment, engagement advertisements are stand-alone experiences that can be accessible from any computer web browser or mobile phone without any installation required by the viewer.

Engagement advertisements created using the self-service engagement platform include multimedia presentations or advertising experiences that promote a brand, media content (e.g., television series, movie, book, music), or other such goods or services. In one embodiment, a viewer initiates an engagement advertisement by clicking on a representation of the advertisement (e.g., an image or link) and then providing inputs to the advertisement based on its content and format.

An engagement advertisement preferably comprises one or more phases, each of which provides certain content and calls for certain interactions from the viewer. The phases may require that the viewer actively input one or more responses to advance from one phase to the next. In one embodiment, an engagement advertisement can have conditional or alternative phases, where the selection of a later phase depends on the viewer's response to a previous phase. The type of responses that may be provide by a viewer for a phase include, for example, answering questions, uploading a video, taking surveys, playing games, participating in polls, or any combination thereof. In one embodiment, a viewer receives remuneration for interacting with an engagement advertisement.

The self-service engagement advertising platform enables an advertiser to create an engagement advertisement without having to have any technical background, computer programming, or skills as a graphic artist. Rather, the self-service engagement advertising platform provides a number of easily customizable engagement advertisement templates from which the advertiser can select and then customize for their specific needs. The templates contain code and data for establishing a fully functional engagement advertisement. In one embodiment, the self-service engagement advertising platform allows the advertiser to launch and manage an entire campaign based on engagement advertisements.

### System Architecture

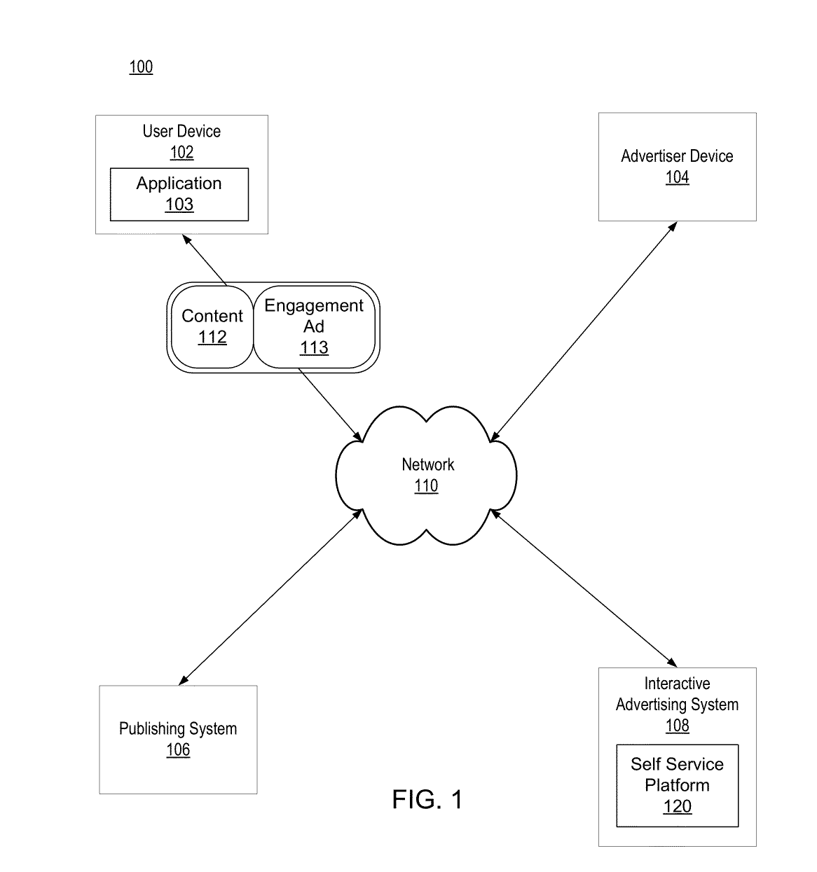

FIG. 1 is a high-level block diagram of an environment 100 in which the self service advertisement platform can be operated, according to one embodiment. The illustrated environment 100 includes a user device 102, an advertiser device 104, a publishing system 106, and interactive advertising system 108 connected via a network 110. In one embodiment, the network 110 is the Internet, but may also be any network, including but not limited to a LAN, a MAN, a WAN, a mobile, wired or wireless network, a private network, or a virtual private network, and any combination thereof. It is understood that the these devices are all computer-implemented devices and comprise as appropriate to their operations, one or more processors, memory and storage devices, and networking devices and capabilities.

Although FIG. 1 only illustrates a single user device 102, advertiser device 104, and publishing system 106, it should be understood that large numbers of each entity are supported and can be in communication with the interactive advertising system 108. One of each entity is illustrated in order to simplify and clarify the description.

The user device 102 represents a device that allows a user to view and interact with engagement advertisements 113 created using the self-service engagement advertising platform 120. In one embodiment, the engagement advertisements 113 are presented to a user via an application 103 executed by the user device 102. The application 103 can be a web browser, a mobile application such as a game, news and/or feed reader, music player, media manager, social networking application, and so forth. The types of applications in which engagement advertisements 113 can be placed is not limited by the invention.

The advertiser device 104 represents a device used by an advertiser to communicate with the interactive advertising system 108 to access the self service engagement advertising platform 120. Through the advertising platform 120, an advertiser is able to create engagement advertisements 113 and manage the parameters of engagement advertisements and campaigns, such as the start/stop dates, bid value, and budget.

The publishing system 106 represents a system that provides content to the user device 102 for presentation to the user of the device 102. The content provided by publishing system 106 can be in any number of forms, including web pages, multimedia content (e.g., videos, music, animations, etc.), games, or the like. The content is received by the user device 102 and output by the application 103 executing on the device.

In one embodiment, a placement opportunity for an engagement advertisement 113 occurs when content 112 is going to be provided to the user device 102 by the publishing system 106. Generally, the publishing system 106 requests from the interactive advertising system 108 an engagement advertisement 113 to present to the user along with the content 112. In one embodiment, with the request the publishing system 106 provides information about the user to whom the content 112 is going to be presented, such as an identifier of the user, location, age, gender, or any other demographic information about the user.

In one embodiment, the publishing system 106 receives from the interactive advertising system 108 a representation of a selected engagement advertisement 113. The representation of the engagement advertisement 113 is included with the content 112 and transmitted to the user device 102 for presentation. In one embodiment, the representation is an image, a video, or a link that when clicked, swiped, selected, or otherwise activated, causes the engagement advertisement 113 to be loaded on the user device 102 and presented to the user via the application 103. In another embodiment, instead of transmitting a representation of the engagement advertisement 113, the actual engagement advertisement is included and presented with the content 112. For example, if the content 112 is a webpage, in this embodiment the engagement advertisement 113 may be embedded within the webpage.

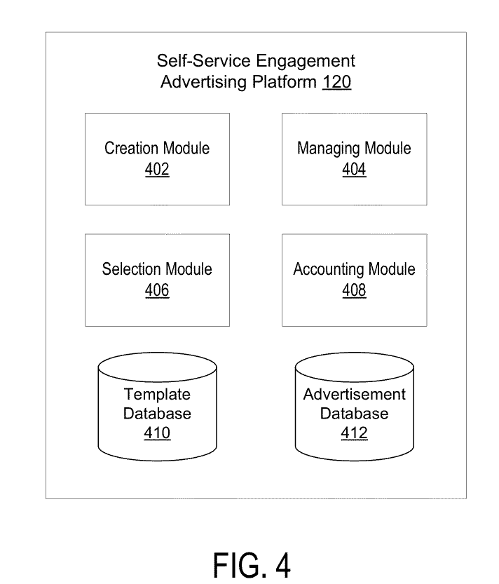

The interactive advertising system 108 represents a system that provides the self-service engagement advertising platform 120. As shown in FIG. 4, the self-service engagement advertising platform 120 includes a creation module 402, a managing module 404, a selection module 406, and an accounting module 408. These modules together implement the self-service engagement advertising platform. Many conventional features, such as firewalls, load balancers, application servers, failover servers, site management tools and so forth are not shown so as not to obscure the features of the system.

The creation module 402 communicates with an advertiser via the advertiser device 104 to enable the advertiser to create engagement advertisements. When an advertiser requests to build an engagement advertisement 113, the creation module 402 presents to the advertiser a plurality of different templates available for creating an advertisement. The templates are stored in a template database 410.

A template provides the framework for an engagement advertisement 113, along with specific attributes that can be customized by the advertiser. Each template is configured to be bound to one or more executable code modules that can be executed by the user device 102 to present an engagement advertisement along with the customized portions. The customized portions are configured by the advertiser using the creation module 402 as an advertiser builds the advertisement. For this reason, an advertiser with no technical background is able to use the advertising platform provided interactive advertising system 108 to create an engagement advertisement 113.

At least one template is provided for each of a plurality of different types of engagement advertisements. In one embodiment, the templates include a media content template, a quiz template, a poll template, a survey template, a game template, and an open-ended template.

The media content template is used to create an engagement advertisement where one way a user interacts with the advertisement is by uploading media content, such as an image or video. This template is useful, for example, where the advertiser is interesting in having the user provide user-generated content (e.g., self recorded videos) in response to the advertisement, such as videos having content associated with the advertiser or a particular brand. The media content template is customizable by the advertiser to specify the type or types of media files that the viewer may upload, along with collateral information describing the desired content of the media (e.g., solicitation for videos about a particular brand).

The quiz template is used to create an advertisement where the user interacts with the advertisement is by answering one or more questions, such as multiple choice questions, yes-no questions, rating questions, or the like. The quiz template is customizable by the advertiser to specify the number of questions, the content of each question, and the set of available answers that the user may select from.

The poll template is used to create an advertisement where the user interacts with the advertisement by casting a vote. The poll template is customizable by the advertiser specifying the issue being voted on, and the available voting options (e.g., for/against, agree/disagree, etc.).

The survey template is used to create an advertisement where a user interacts with the advertisement by answering one or more survey questions. The survey template is customizable by the advertiser specifying the survey questions and the types of responses that the user can provided.

The game template is used to create an advertisement where the user interacts with the advertisement by playing a game. The game template is customizable by the advertiser specifying the game mechanics and scoring behavior for the user.

The open-ended question template is used to create an advertisement where the user interacts with the advertisement by answering an open-ended question. This template is customizable by the advertiser specifying the open-ended question.

Preferably, each template includes certain phases with formatting and content associated with the type of the template. For example, the quiz template may include a question phase with the formatting for setting up a question to ask a user. The phases are customizable according to the needs of the advertiser. In one embodiment, certain phases of a template must be included as part an engagement advertisement created using the template.

When the advertiser selects a template to use for creating the engagement advertisement, the creation module 402 retrieves from the template database 410 the selected template which includes the phases associated with the template. The creation module 402 presents template to the advertiser via a user interface. The user interface allows the advertiser to customize the template.

As noted above, an engagement advertisement can include multiple phases (“multi-phase advertisement”). Accordingly, customizing a template for a multi-phase advertisement includes the advertiser indicating which phases to include as part of the advertisement, the content of each phase, and the order in which the phases are to be presented to a user, and whether a given phase is conditional or dependent on the user's response to a prior phase. For example, a survey advertisement may have two phases, phase 1 in which a true/false question is presented, and phase 2 in which there are two alternative phases 2A and 2B. The advertiser may indicate if user's answer provided in the first phase is true, then phase 2A is presented and if the answer was is false, then phase 2B is presented.

An engagement advertisement can be configured so that the viewer receives some form of remuneration for interacting with the advertisement. Accordingly, the advertiser can indicate which interactions with the engagement advertisement are considered a remuneration event. A remuneration event is a response (or set of responses) which when provided by a user results in the user receiving remuneration for interacting with the advertisement. The advertiser can define the remuneration event as a response to one or more, or all phases of the advertisement. For example, where the advertisement is a first phase with a video, followed by a second phase with a survey having three questions, the advertiser can define the remuneration event to be the viewing of the video in the first phase followed by the user providing responses to all three questions in the second phase. In one embodiment of the platform, the advertiser can also define multiple different remuneration events for an advertisement.

In one embodiment, the advertiser can define the particular type of remuneration and the mechanism or context in which it is provided to the user. In one embodiment, the remuneration is provided to the user by the publishing system 106. The remuneration may be, for example, money, virtual currency, social media currency, or reward points that can be redeemed for goods or services within the publishing system 106. It may also be free mobile phone minutes, applications, or services, or credits for such minutes, apps, or services. Generally, when specifying the amount of remuneration, the advertiser identifies the remuneration in terms of what is acceptable within the publishing system 106. For example, assume that the publishing system 106 is a gaming website that creates a virtual world for users. If a user completes a remuneration event, the user may receive as remuneration a specified number of units of virtual currency to use in the virtual world provided by the publishing system 106.

By providing remuneration the user becomes more engaged with the advertisement than he would have otherwise. Optionally, the advertiser can further customize an advertisement by specifying where in the advertisement the user is informed that he may be remunerated. For this embodiment, the advertiser can specify that this information is provided to the user either before the engagement advertisement is activated by the user, after the advertisement is activated, but before the advertisement has been completed, or at the completion of the engagement advertisement. In all of these instances, the remuneration creates a positive association with the good or service being advertised, and encourages the user to engage with other advertisements for the good or service.

In one embodiment, as part of the customization the advertiser may also specify which particular types of operating system that the advertisement is to be created for. For example, advertiser can specify that the advertisement be created any or all of operating systems including MICROSOFT WINDOWS™ devices, APPLE iOS™ devices, ANDROID™ devices, or the like. In a further embodiment, the advertiser may also specify the types of devices for the advertisement, such as mobile devices (e.g., smartphones), desktop devices, tablets, set top devices, or the like.

The creation module 402 receives the customization information provided for the template from the advertiser device 104. Based on the customizations and the template, the creation module 402 creates the engagement advertisement. Where the advertiser provides customization information identifying the operating system platform type, the creation module 402 creates multiple versions of the advertisement where each version is for a selected type of operating system, using the appropriate code modules to enable execution of the advertisement on the selected operating system.

The creation module 402 stores the created engagement advertisement in an advertisement database 412. In one embodiment, along with the advertisement, the creation module 402 stores an indication of the advertiser and an indication as to a campaign that the advertisement is a part of. A campaign includes one or more engagement advertisements that are promoting a particular idea, brand, product, or service. The advertiser indicates which campaign the advertisement belongs to.

In one embodiment, along with the advertisement, the creation module 402 additionally stores parameters provided by the advertiser for the advertisement and/or campaign to which it belongs. These parameters include targeting parameters, price parameters, and schedule parameters. Targeting parameters describe the characteristics of the users to which the advertiser desires the engagement advertisement to be presented (i.e., the characteristics of the target audience). Target parameters may include demographic characteristics, for example, gender, age, location, hobbies, and type of job.

The price parameters describe pricing information used by the system 108 in determining whether to present the advertisement. The price parameters include, for example, a bid per engagement and a budget for a set time period. A bid per engagement is the amount the advertiser has committed to pay each time a user interacts with the engagement advertisement. The budget is total amount the advertiser is willing to pay in the set time period for the advertisements of the campaign. Each time a user interacts with an advertisement of the campaign during a set time period, the bid amount of the advertisement is subtracted from the budget. However, the remaining budget amount is not allowed to be negative. The schedule parameters indicate a time period when the advertisements of the campaign are active and should be available to be presented to a user.

The managing module 404 communicates with an advertiser via the advertiser device 104 to manage campaigns and engagement advertisements. The managing module 404 allows an advertiser to edit the parameters of campaigns and of individual engagement advertisements. When the managing module 404 receives a request to edit the parameters of a campaign or advertisement, the managing module 404 edits the parameter information stored in the advertisement database 412 according to the request.

The selection module 406 manages requests for engagement advertisements from the publishing system 106. In one embodiment, when the selection module 406 receives a request for an engagement advertisement to present with content to a user, the selection module 406 identifies information about the user included in the request (e.g., age, gender, location). The selection module 406 uses the user information included in the request to search the advertisement database 412 for candidate engagement advertisements that are still active and whose target parameters match the user information. In one embodiment, an advertisement is active if the scheduled time period of the advertisement has not expired and the campaign of the advertisement still has remaining budget.

With the advertisements found in the search, the selection module 406 selects a candidate engagement advertisement. In one embodiment, the selection module 406 determines which candidate engagement advertisement to select based on the bid per engagement and performance information of each candidate advertisement. Performance information for an advertisement may include one or more the following: the number of times the advertisement has been requested for loading (“presentations”), the number of times a user has interacted with the advertisement up to the last phase (“completions”), and the amount of interaction users have had with the advertisement. Generally, the selection module 406 selects the candidate advertisement that provided the highest expected revenue, which is a function of the bid per engagement, and the rate of completed engagement (e.g., ratio of completions to presentation).

The selection advertisement 406 provides the publishing system 106 a representation of the engagement advertisement selected so that the representation can be presented on the user device 102. When the selection module 406 receives a request for the engagement advertisement from the user device 102, meaning that the user requested the advertisement through the representation, the selection module 406 retrieves the engagement advertisement and provides it to the user device 102.

When the engagement advertisement is presented at the user device 102 to a user, the user is able to interact with the advertisement and able to progress through the different phases of the advertisement. In one embodiment, the engagement advertisement tracks interactions the user engaged in with the advertisement (i.e., the inputs and responses provided to the advertisement by the user) and the content of those interactions (i.e., what those inputs consisted of). The interactions can be as part of form submissions or other page elements used to provide the interactive features of the advertisement. For example, if the user answers a question of the advertisement, the engagement advertisement tracks which question was answered and the answer. The selection module 406 receives the interaction information from the user device 102 and stores it in the advertisement database 412. The interaction information is made available to the advertiser of the engagement advertisement.

The accounting module 408 monitors for remuneration events and tracks the amount owed by an advertiser. When accounting module 408 receives an indication from the user device 102 that a user of the device 102 has interacted with an engagement advertisement in a way that constitutes a remuneration event for the advertisement, the accounting module 408 sends a request to the publishing system 106 that it remunerate the user. In one embodiment, the accounting module 408 notifies the publishing system 106 of what the remuneration should be for the remuneration event.

The accounting module 408 tracks for each engagement advertisement, the amount owed by the advertisement's respective advertiser for making the advertisement accessible to users. In one embodiment, the amount owed is determined based on the bid per engagement of the advertisement and the number of times users interacted/engaged with the advertisement. Typically, at the end of a billing cycle, the accounting module 408 invoices each advertiser for the amount owed.

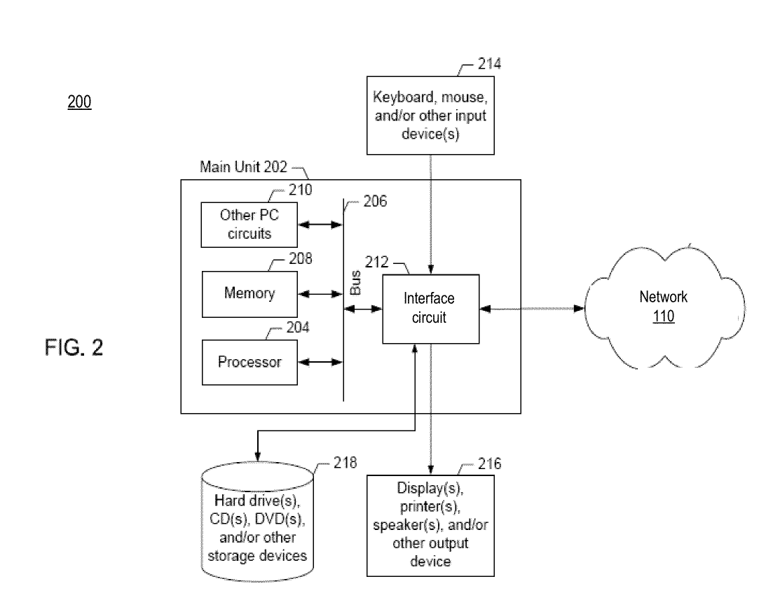

FIG. 2 is a high-level block diagram illustrating a functional view of a typical computer system 200 for use as one of the entities illustrated in the environment 100 of FIG. 1. In one embodiment, the computer system 200 includes a main unit 202 which includes one or more processors 204 electrically coupled by an address/data bus 206 to one or more memory devices 208, other computer circuitry 210 and one or more interface circuits 212. The processor 204 may be any suitable microprocessor.

The memory 208 preferably includes volatile memory and non-volatile memory. In one embodiment, the memory device 208 stores software instructions, webpages, user data and other information for use by the system 200. It will be appreciated that many other data fields and records may be stored in the memory device 208 to facilitate implementation of the methods and apparatus disclosed herein. In addition, it will be appreciated that any type of suitable data structure (e.g., a flat file data structure, a relational database, a tree data structure, etc.) may be used to facilitate implementation of the methods and apparatus disclosed herein.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint and/or a voice recognition system.

One or more displays, printers, speakers and/or other output devices 216 may also be connected to the main unit 202 via the interface circuit 212. The display 216 generates visual displays of data generated during operation of the computer system 200. The visual displays may include prompts for human input, run time statistics, calculated values, data, etc.

One or more storage devices 218 may also be connected to the main unit 202 via the interface circuit 212. For example, a hard drive, CD drive, DVD drive, flash memory drive and/or other storage devices may be connected to the main unit 202. The storage devices 218 may store any type of data used by the computer system 200. The computer system 200 may also exchange data with other entities via a connection to the network 110.

The computer system 200 is adapted to execute computer program modules. As used herein, the term “module” refers to computer program instructions and/or data for providing the specified functionality. A module can be implemented in hardware, firmware, and/or software. In one embodiment, the modules are stored on the storage device 218, loaded into the memory 208, and executed by the processor 204.

The computer systems 200 utilized by the various entities of FIG. 1 can vary depending upon the embodiment and the processing power utilized by the entity. For example, the user device 102 and advertiser device 104 may require less processing power than the publishing system 106 and the interactive advertising system 108. Thus, the user device 102 and advertiser device 104 can be, for example, a standard personal computer system or a mobile device, such as a mobile phone or tablet. In contrast, the publishing system 106 and interactive advertising system 108 may comprise more powerful computers and/or multiple computers working together to provide the functionality described herein.

### PROCESSES/EXAMPLES

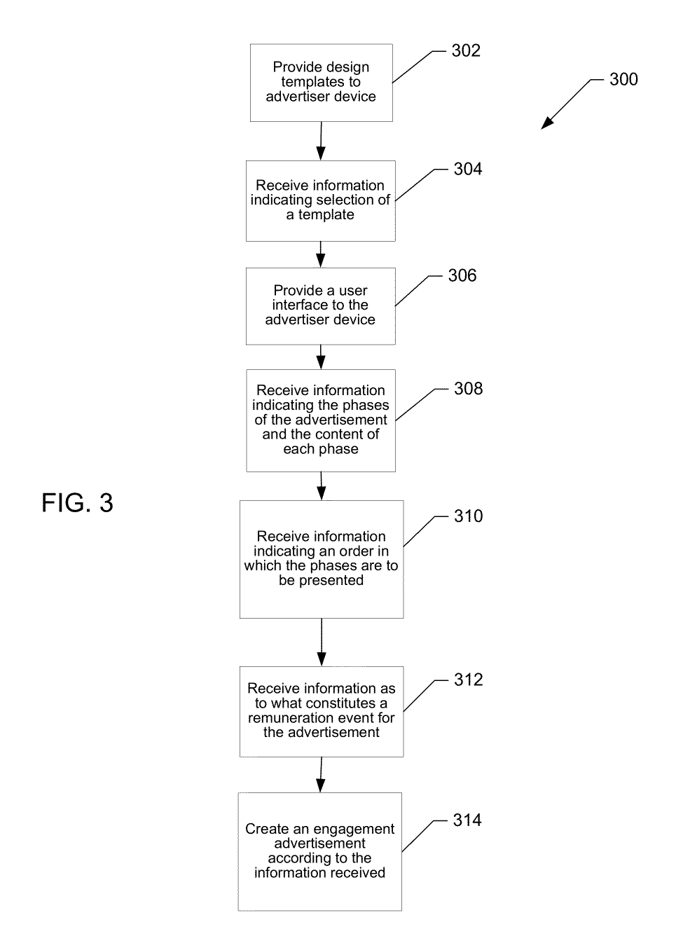

FIG. 3 illustrates a flow diagram of a process 300 executed by the interactive advertising system 108 for facilitating building an engagement advertisement according to one embodiment. Preferably, the process described herein is at least partially embodied in one or more software programs which are stored in one or more memories and executed by one or more processors. Although the process is described with reference to the flowcharts, it will be appreciated that many other methods of performing the acts associated with process 300 may be used. For example, the order of the process's steps may be changed and some of the steps described may be optional.

Assume for purposes of this example that an advertiser has requested to build an engagement advertisement. The interactive advertising system 108 provides 302 multiple design templates to the advertiser device 104 for presentation to the advertiser. The interactive advertising system 108 receives 304 from the advertiser device 104 information indicating a selection of a template. The interactive advertising system 108 provides 306 to the advertiser device 104 a user interface to allow the advertiser to customize the selected template.

The interactive advertising system 108 receives 308 from the advertiser device 104 information indicating which phases of the template will be a part of the advertisement and the content of each phase. The interactive advertising system 108 also receives 310 an order in which the phases are to be presented to a user. Additionally, the interactive advertising system 108 receives 312 information as to what interactions with the advertisement shall constitute a remuneration event. The interactive advertising system 108 creates 314 the engagement advertisements according to the information received.

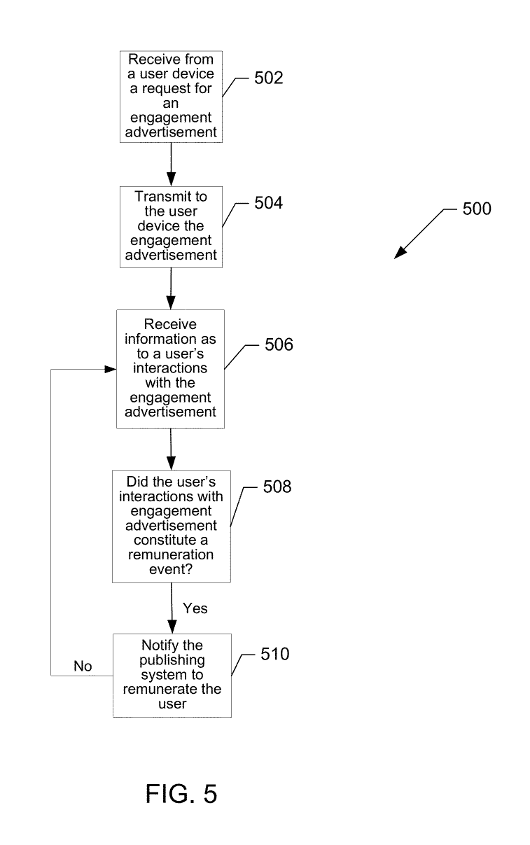

FIG. 5 illustrates a flow diagram of a process 500 executed by the interactive advertising system 108 for presenting an engagement advertisement to a user according to one embodiment. Preferably, the process described herein is at least partially embodied in one or more software programs which are stored in one or more memories and executed by one or more processors. Although the process is described with reference to the flowcharts, it will be appreciated that many other methods of performing the acts associated with process 500 may be used. For example, the order of many of the process's steps may be changed and some of the steps described may be optional.

Assume for purposes of this example that the publishing system 106 has transmitted content to the user device 102 for presentation to a user. The content includes a representation of an engagement advertisement and the user has requested the advertisement via the representation (e.g., by clicking on the representation). The interactive advertising system 108 receives 502 from the user device 102 a request for the engagement advertisement. The interactive advertising system 108 transmits 504 the requested advertisement to the user device 102 for presentation to the user.

The interactive advertising system 108 receives 506 from the user device 102 information as to the user's interactions with the advertisement. In one embodiment, the information is continuously or periodically received as long as the user is interacting with the advertisement. In another embodiment, the information is received when the user closes out the advertisement. Based on the information, the interactive advertising system 108 determines 508 whether the user's interactions constitute a remuneration event of the advertisement. If the interactions constitute a remuneration event, the interactive advertising system 108 notifies 510 the publishing system 106 to remunerate the user.

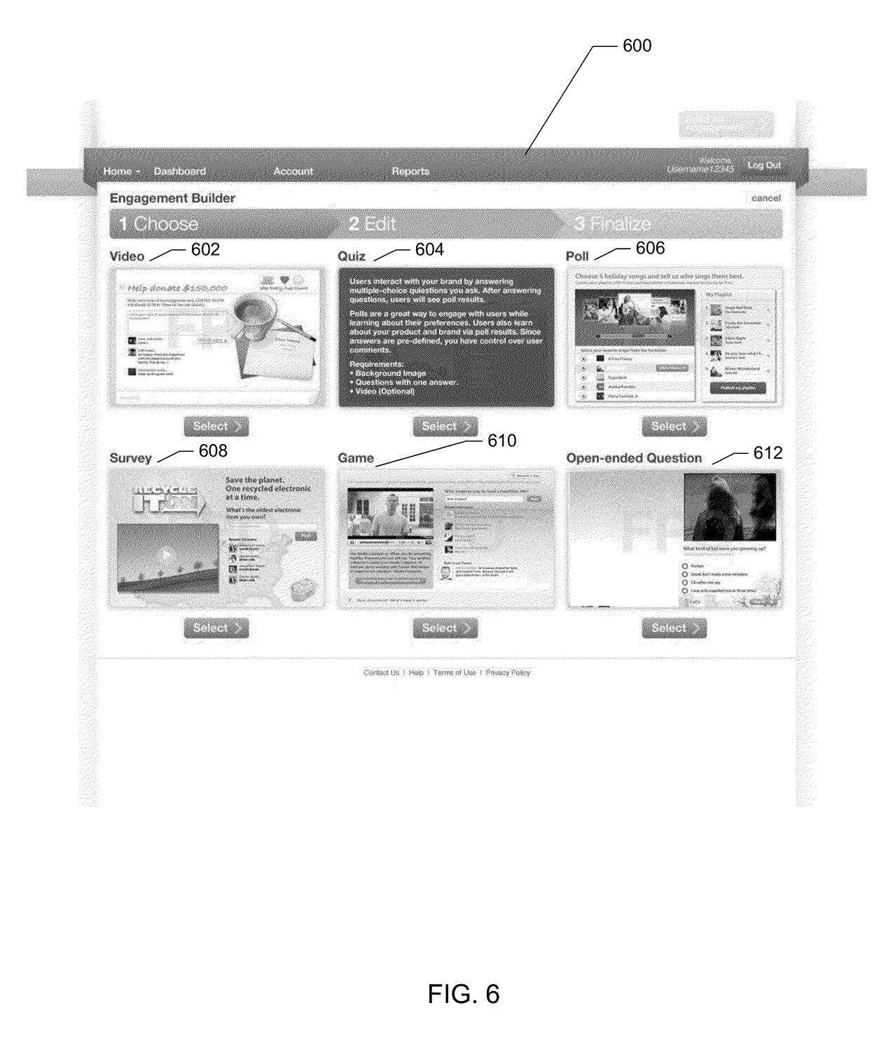

FIGS. 6 to 10 are screenshots of an example user interface of the self-service engagement advertisement platform used to create an engagement advertisement. A non-technical advertiser may build an interactive engagement advertisement by using the example self service engagement advertisement platform of FIGS. 6 to 10.

FIG. 6 illustrates an example screenshot of a template gallery 600 presented to advertiser. The template gallery 600 displays the various design templates that the advertiser can use to create the engagement advertisement. In this example, template gallery 600 includes the following types of engagement advertisement templates: Video 602, Quiz 604, Poll 606, Survey 608, Game 610, and Open-ended Question 612. The templates may be changed or specialized for certain industries or markets.

In one embodiment, the templates are developed through verifiable empirical testing to ensure that the engagement advertisements created using the templates will provide the advertiser with greater brand lift, greater share rates, and greater interaction rates. Presenting the templates in such a manner allows even the novice advertiser to quickly begin building an effective engagement advertisement. As noted above, the templates are associated with an entire software framework enabling their execution, including all of the code, software logic, business logic, phases, and logical connections between phases required to create engagement advertisements.

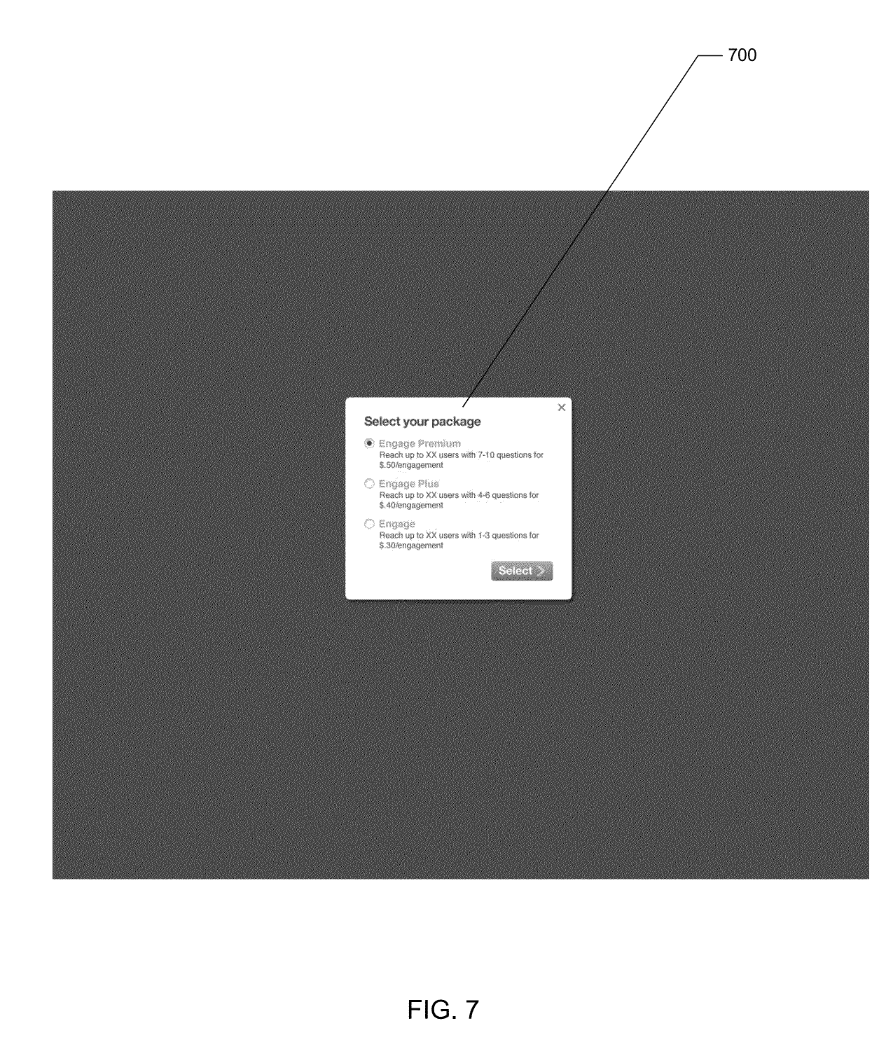

After the advertiser selects a type of template, the advertiser chooses a level of engagement to achieve. As shown in FIG. 7, in prompt 700, the advertiser chooses the number of phases for the advertisement and the length of the phases. In this example, the advertiser can select from phases having 1-3 questions (or other interactions), 4-6 questions, or 7-10 questions.

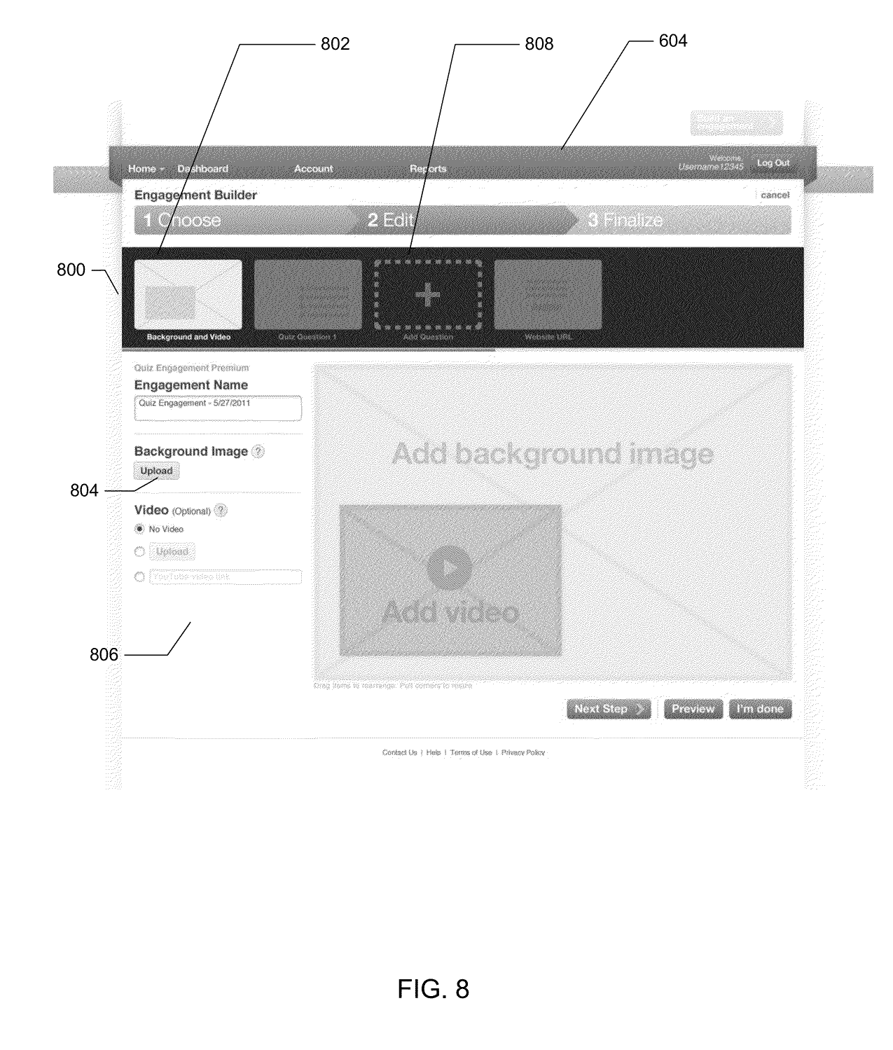

FIG. 8 illustrates an example Quiz template 604 that the advertiser may have selected for building the engagement advertisement. As can be seen, the template provides a framework where a basic template has already been built, but leaves room for the advertiser to customize the template to his specific needs. Thus, the template provides a balance between requiring the advertiser to completely design the engagement advertisement from scratch (e.g., having to learn the code to build an engagement advertisement) or not being involved in the actual building of the engagement advertisement (e.g., having to explain the requirements to a technical advertiser and then letting the technical advertiser actually build the engagement advertisement).

Section 800 illustrates a row of thumbnails of the different phases of the advertisement. The advertiser can easily navigate between the various phases by simply clicking on the thumbnail of a phase he wishes to view or customize. Thumbnail 808 illustrates that an “Add Question” phase can be selected to add another question to the advertisement. In one embodiment, phases can be added up to the number of allowed phases for the advertisement.

FIG. 8 illustrates that for phase 802 the advertiser can specify items such as the background image or a video for the engagement advertisement. The advertiser uses the background image button 804 to select the background image for the advertisement. The advertiser selects a video for the engagement advertisement in area 806. The source of the video may be a local file residing on the user device 102 or a hyperlink to a video on the Internet, or other remote source.

In some embodiments, the advertiser may be able to drag and drop items onto the template. Items that the advertiser can add to the template may include, for example, images, text, buttons, input fields, links, hit areas, shapes, dropdowns, videos, comment boxes, polls, or video files.

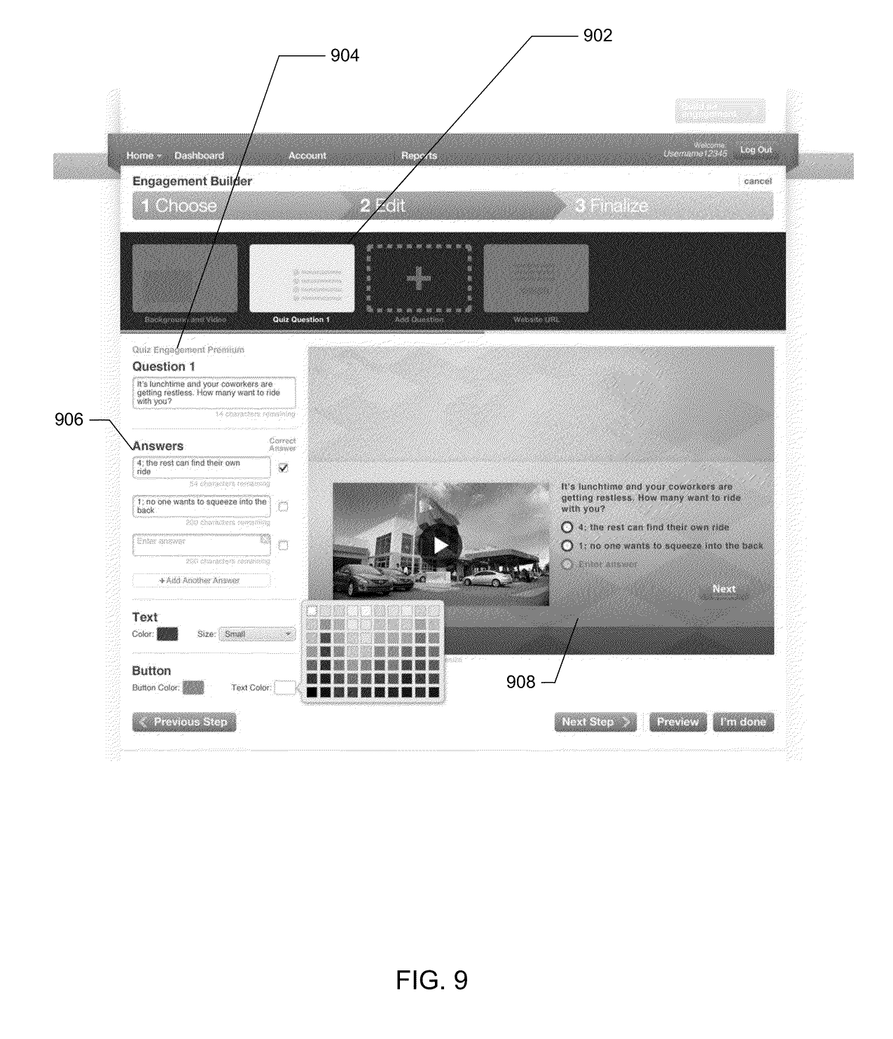

As shown in FIG. 9, after specifying the Background and Video in phase 802, the advertiser navigates to phase 902. At this phase, the advertiser may add a quiz question to the engagement advertisement. The advertiser may specify question 904 in the phase 902 to ensure that the user pays attention and fully engages with the engagement advertisement. The advertiser can specify the choice of answers 906 that the viewer may be able to select as responses, as well indicating which answers are considered “correct,” where that is relevant to the advertiser. Preview window 908 displays what the user will see once the engagement advertisement is deployed and running.

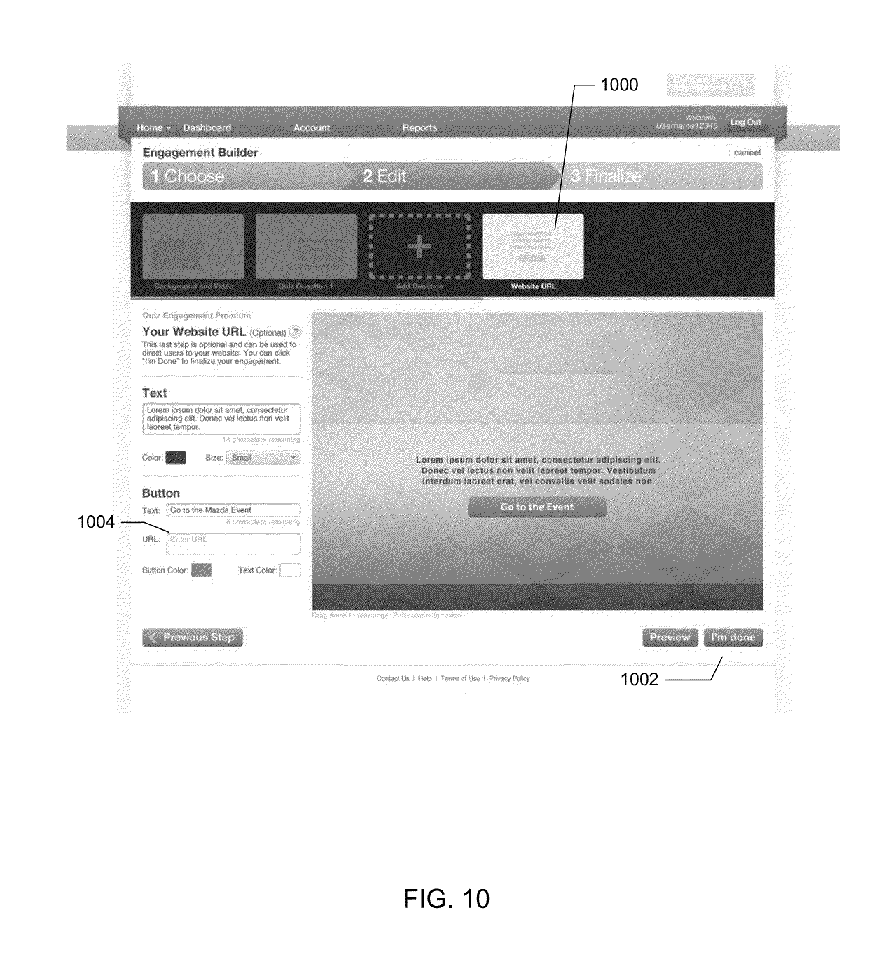

FIG. 10 illustrates a further phase 1000 of the advertisement, where the advertiser uses this phase to give a user an option of being directed a webpage. The URL of the webpage is included by the advertiser in box 1004. An “I′m done” button 1002 is provided in the user interface so that the advertiser can indicate when he is finished designing the engagement advertisement. When the button 1002 is selected, the interactive advertising system 108 creates and stores the advertisement. While the example here in FIG. 6-10 are with respect to a quiz template, the general flow and editing features are the same with respect to the other types of advertisement templates.

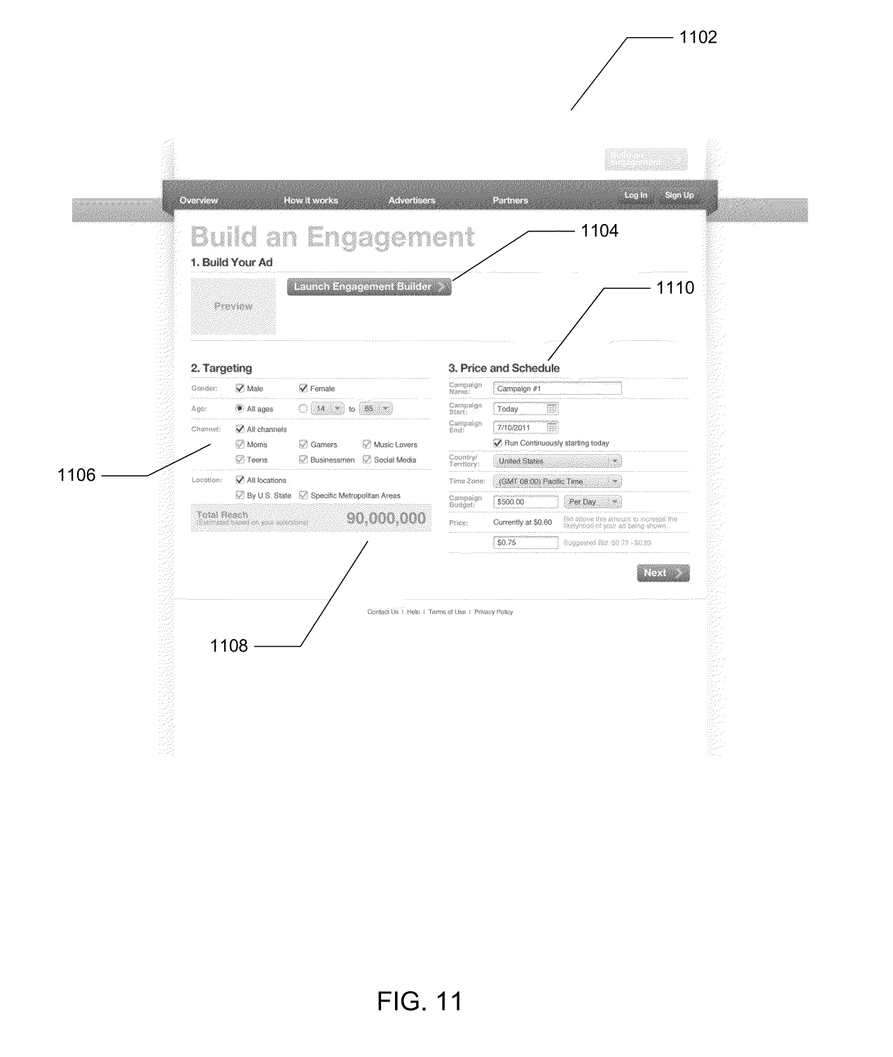

FIGS. 11 to 18 illustrate example screenshots of those portions of the self-service engagement advertisement platform used to create and manage advertising campaigns for use with one or more engagement advertisements. Advertisers use this aspect of platform to define parameters of an advertising campaign and of individual engagement advertisement. In one embodiment, the platform allows an advertiser to first state the goal of an engagement advertisement and then develop the engagement advertisement specifically designed to meet the already-stated goal.

FIG. 11 illustrates an example screenshot of a user interface of a campaign editor 1102 configured for creating a campaign. The campaign editor 1102 allows an advertiser to name a campaign, and provide specific targeting parameters, price parameters, and schedule parameters of the campaign. Specifically, as shown in area 1106, the advertiser provides the targeting parameters that describe the demographic characteristics of the audience that the engagement advertisement will target. As targeting parameters the advertiser may specify the gender and the age of the targeted audience. The advertiser may also specify one or more channels that describe the type of people that will be targeted. For example, the advertiser may be able to target Moms, Gamers, Music Lovers, Teens, Businessmen, or a Social Media audience. Each channel is defined by various combinations of demographic attributes, such as gender, age, family size, interests, income, and the like. Being able to select a channel enables the advertiser to more easily target their advertisement, without having to have the expert knowledge typically necessary to know the precise demographic attributes for targeting a specific audience. The advertiser may also be able to specify the location of the targeted audience. The targeting may be general or high-level (e.g., the advertiser only targets males) or it may be very specific (e.g., the advertiser targets 30 to 35 year old mothers who reside in Chicago and are interested in music).

Given the targeting parameters, campaign editor 1102 automatically calculates an estimated total reach 1108 by using previously collected data and demographic information stored in databases. The total reach 1108 is an estimate of potential number of persons to whom the engagement advertisement is likely to be shown, based on the selected targeting parameters. The total reach 1108 is interactively updated as the advertiser changes the targeting selections 1106. In this manner, the advertiser can fine tune the scope of the campaign. In the example of FIG. 11, given the targeting parameters for an audience of both males and females of all ages, all channels, and all locations, the total reach is estimated at 90M individuals. Restricting any of the parameters (e.g., males only, California) would reduce the total reach.

Pricing and schedule area 1110 allows the advertiser to specify the price parameters and the schedule parameters of the campaign. The pricing parameters gives the advertiser granular control over the money spent on the campaign. FIG. 11 shows that as pricing parameters that advertiser can define the campaign budget amount and the bid price per engagement. As schedule parameters the advertiser can indicate when the campaign starts and when the campaign stops.

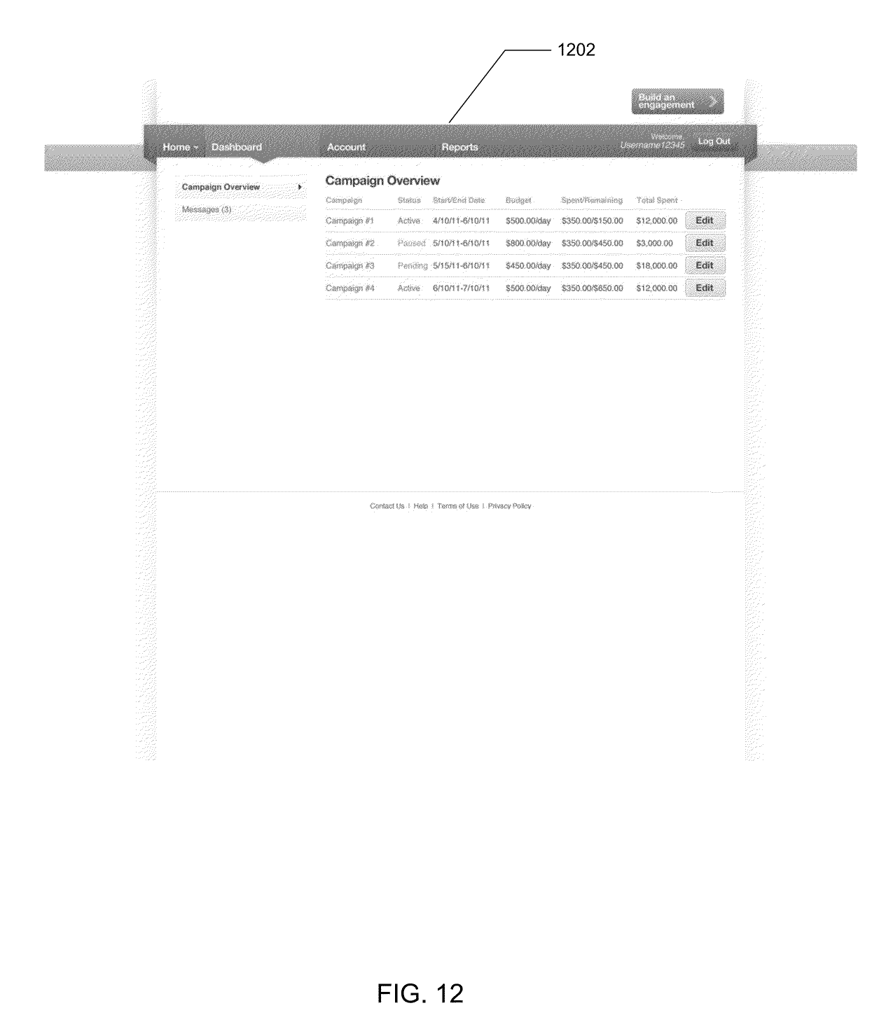

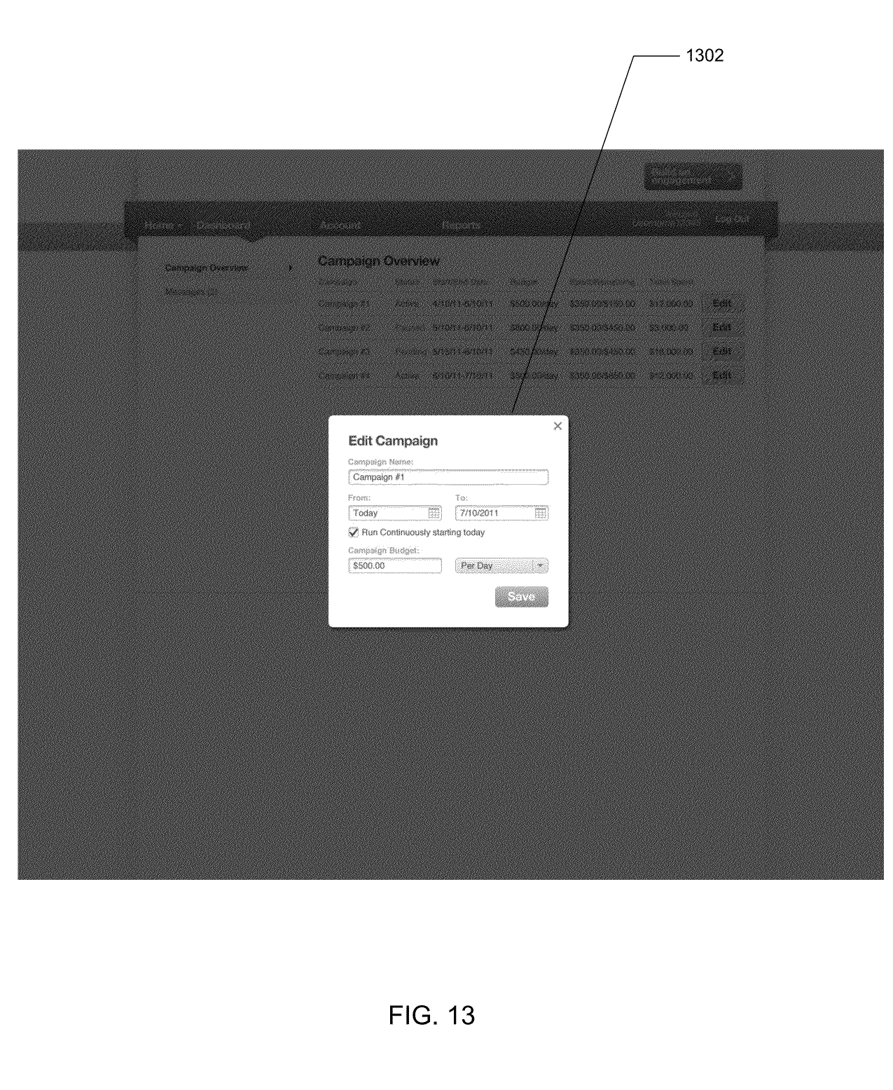

FIG. 12 illustrates an example screenshot of a campaign overview manager 1202. The advertiser may have multiple campaigns running simultaneously. The campaign overview manager 1202 allows the advertiser to quickly see for each campaign the targeting data, start/stop dates, and total budget. The advertiser can also quickly see how much of the daily budget has been spent and how much remains, as well as total spent on the campaign to date. The advertiser can click on any of the campaign names in the Campaign column to access the campaign editor 1102. As illustrated in FIG. 13, the advertiser can also modify the parameters of a campaign—such as targeting data, start/stop dates, and total budget—at any time using prompt 1302.

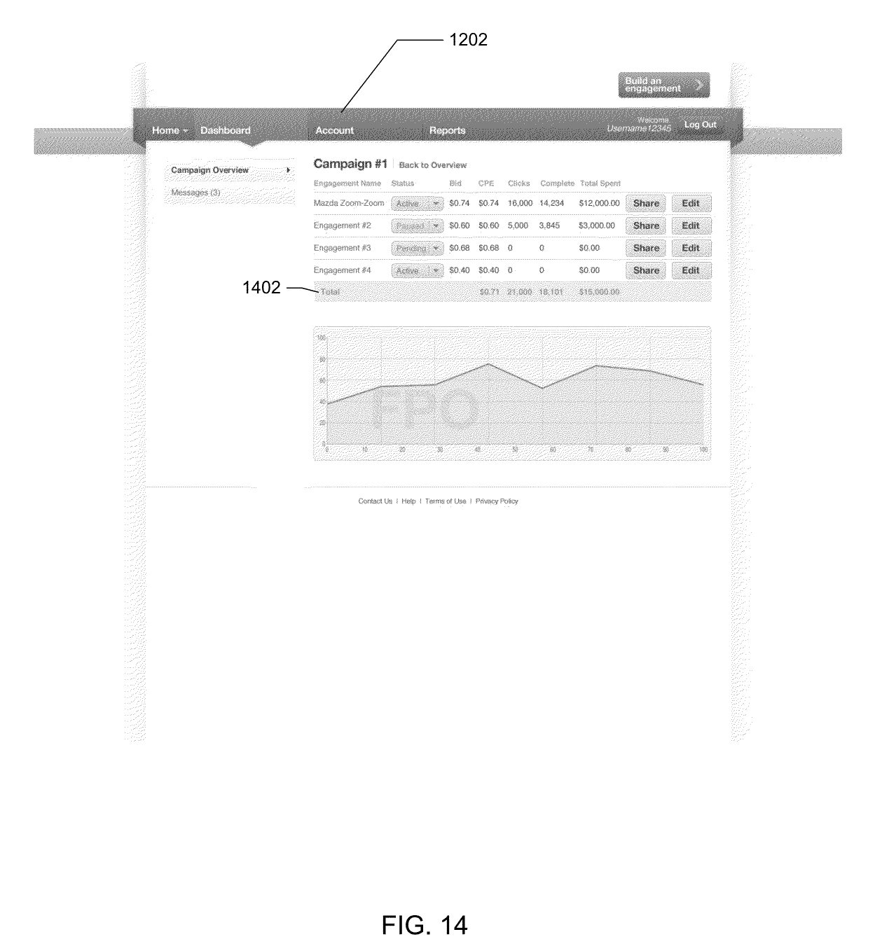

Referring now to FIG. 14, the campaign overview manager 1102 is configured to enable the advertiser to examine each individual campaign in detail. As noted above, a campaign can include multiple engagement advertisements, such as illustrated in FIG. 14. In this example, as part of a single campaign, an advertiser has five different engagement advertisements that target different audiences with different messages. The manager 1102 shows whether an engagement advertisement is active (and includes a control by which the advertiser can change the status of the advertisement from Paused, to Pending, to Active), the average bid for the engagement advertisement, the CPE (cost-per-engagement), the total number of activations (“clicks”) on each engagement advertisement, the number of engagements completed, and the total money spent on that engagement advertisement. The manager 1102 also shows the respective totals 1402 across all engagements for the campaign. The manager 1102 allows the advertiser to assign different budgets to engagements by choosing to spend more resources on certain engagements within a campaign, giving the advertiser full control in creating an engagement advertisement. In one embodiment, the advertiser can specify a total campaign budget (e.g., 100 k), and then specify weights (e.g., 30%, 15%, etc.) for individual engagements within that campaign. Then, as weights for individual engagements are changed by the advertiser, the advertiser can see the overall net change in Total Reach across the entire campaign in real-time. FIG. 14 also allows the advertiser to view how many engagement advertisements have been created as part of one campaign.

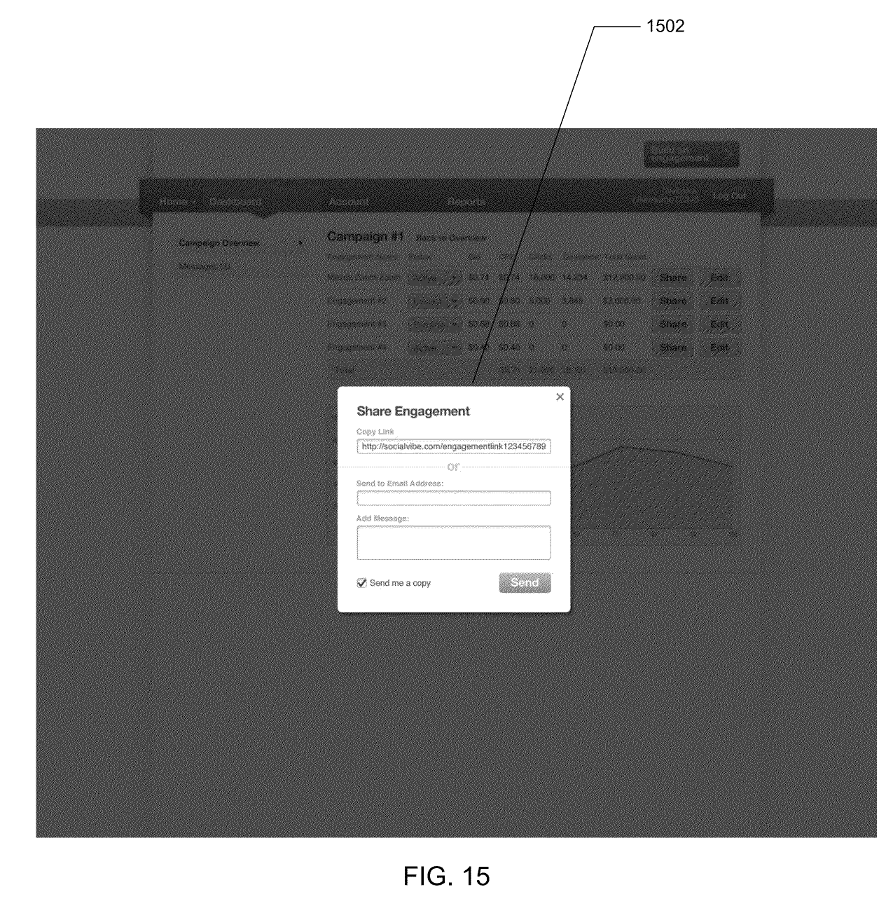

As illustrated in FIG. 15, the campaign manager 1102 can be configured in one embodiment to enable the advertiser to share an engagement advertisement with his or her peers or co-workers from directly within the platform using prompt 1502. This enables the advertiser to collaborate with others on defining any of the parameters for the engagement, as well as evaluating its effectiveness.

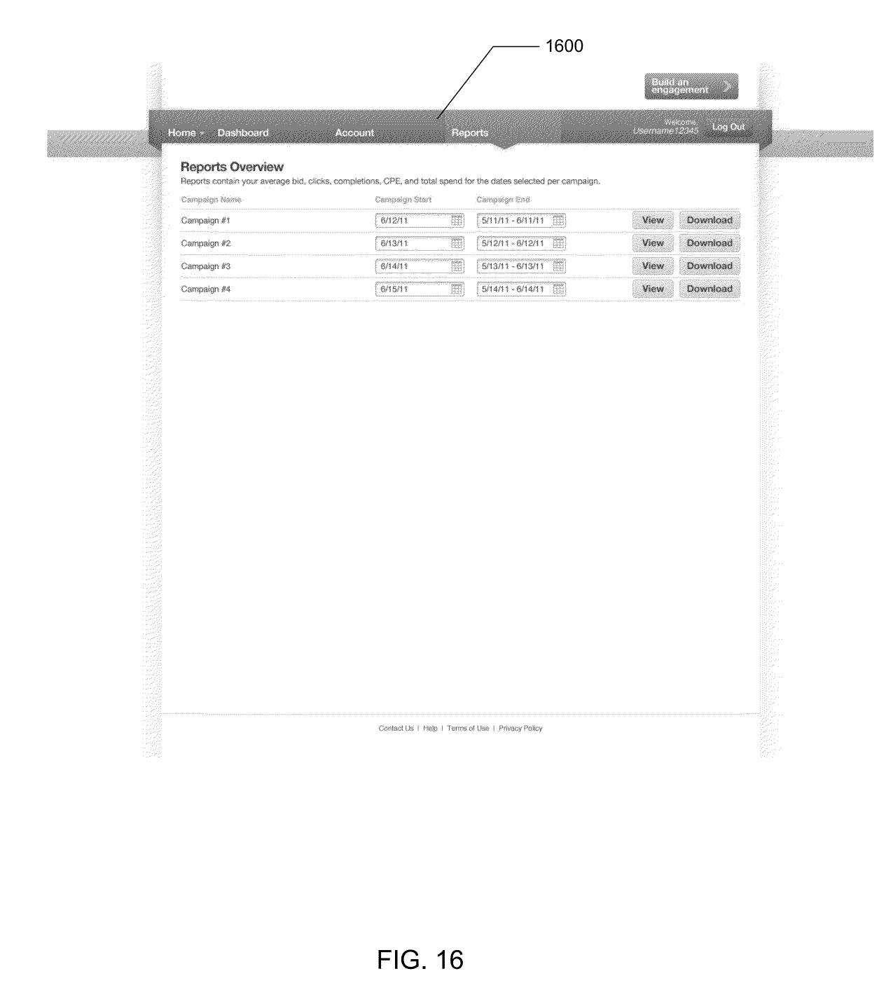

Referring now to FIG. 16, the self-service engagement advertisement platform further include a report manager 1600 that is configured to generate reports about the effectiveness of each campaign within specific dates. The reports may be viewed or downloaded. Such reporting tools provide the advertiser with an ability to understand the effectiveness of the engagement advertisement.

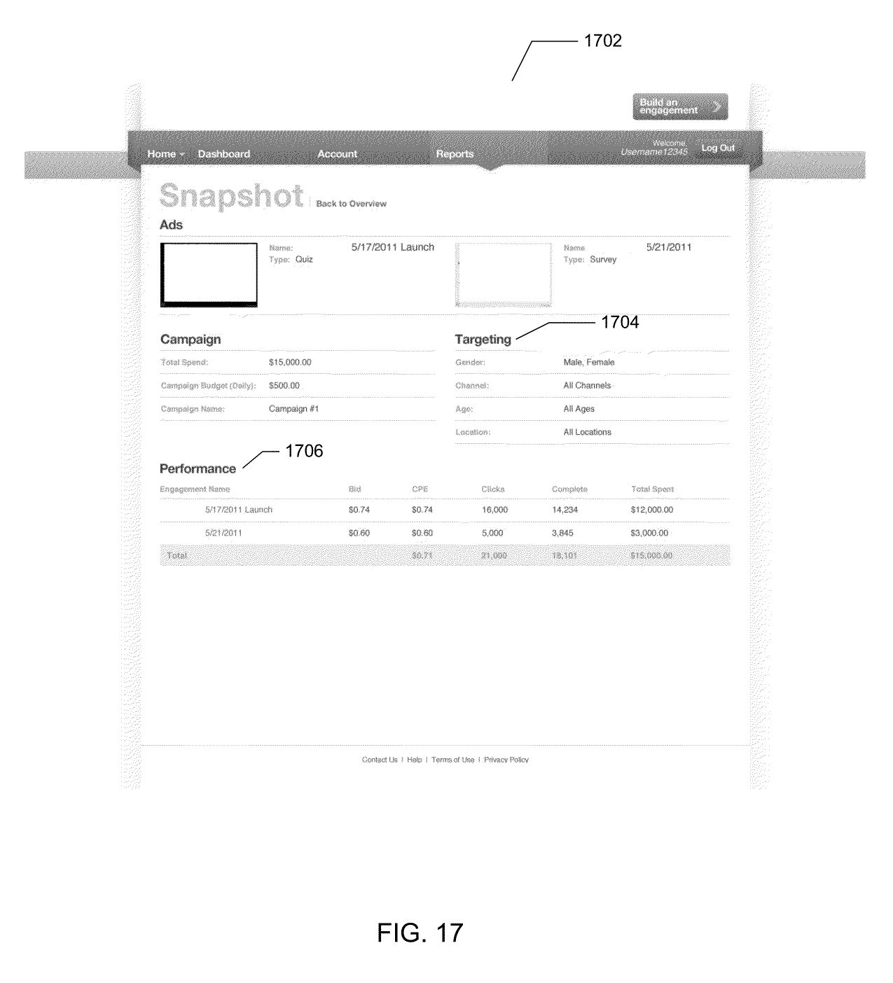

FIG. 17 illustrates an example report 1702 that provides information about a campaign. Specifically, the report 1702 informs the advertiser about the targeting parameters 1704 for the campaign, and performance indicators 1706.

In one embodiment, the self-service engagement advertisement platform allows automatically measuring and storing key performance indicators associated with the engagement advertisements.

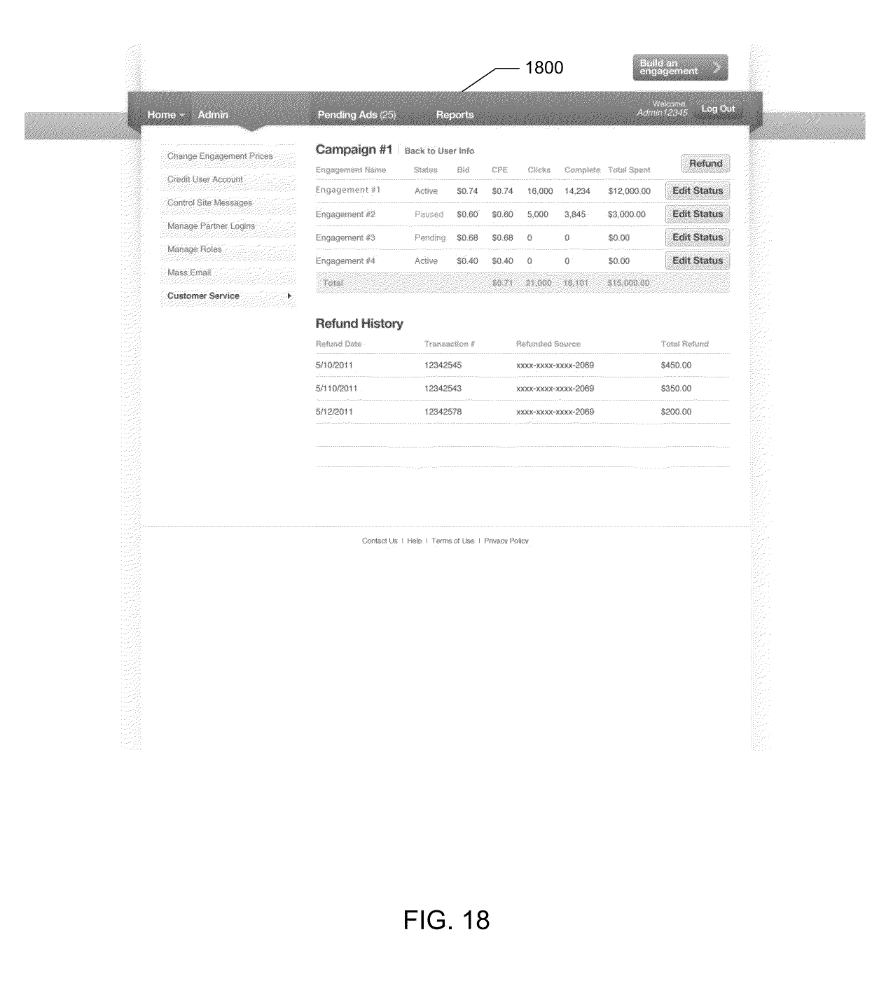

FIG. 18 is an example screenshot 1800 illustrating that the advertiser can perform various administrative tasks for the engagement advertisements and campaigns. This further assists even a non-technical advertiser to effectively market, brand, and advertise goods or services using engagement advertisements.

In summary, persons of ordinary skill in the art will readily appreciate that systems and methods for building engagement advertisements have been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

What is claimed is:

1. A method for facilitating creating an engagement advertisement by an advertiser, the method comprising:
providing a plurality of design templates to an advertiser;
receiving template information indicating selection by the advertiser of at least one of the plurality of design templates to use for creating an engagement advertisement, the selected template including a plurality of phases;
providing a graphical user interface to the advertiser to allow the advertiser to customize the selected template;
receiving customization information indicating which of the plurality of phases will be a part of the engagement advertisement, content of each phase that will be a part of the engagement advertisement, and an order for presenting the phases; and
creating the engagement advertisement according to the customization information received.

2. The method of claim 1, further comprising
receiving information indicating interactions with the engagement advertisement that result in a user receiving remuneration for interacting with the advertisement.

3. The method of claim 2, wherein the advertiser indicates that a user reaching a last phase of the engagement advertisement results in the user receiving remuneration.

4. The method of claim 1, further comprising:
transmitting the engagement advertisement to a user device for presentation to a user;
receiving interaction information describing interactions by the user with the engagement advertisement; and
responsive to the interactions by the user constituting a remuneration event, determining to remunerate the user for the interactions with the engagement advertisement.

5. The method of claim 4, further comprising:
notifying a publishing system to remunerate the user, including an amount to remunerate the user, wherein the publishing system provided content to the user device that allowed the user to access the engagement advertisement.

6. The method of claim 4, wherein the user chooses the remuneration from multiple options.

7. The method of claim 1, further comprising receiving information from the advertiser defining interactions that are to be completed by a user to complete a phase of the engagement advertisement.

8. The method of claim 1, wherein the selected design template includes a framework for the engagement advertisement that allows for customization.

9. The method of claim 8, wherein the framework describes an appearance of the engagement advertisement.

10. The method of claim 8, wherein the framework describes phases of the selected template that are required to be a part of the engagement advertisement.

11. The method of claim 1, further comprising receiving targeting parameters for the engagement advertisement, the targeting parameters describing characteristics of a target audience for the engagement advertisement.

12. The method of claim 1, further comprising receiving payment parameters and schedule parameters for the engagement advertisement, the payment parameters describing pricing information for the advertisement and the schedule parameters describing a time period when the advertisement is active.

13. A non-transitory computer readable medium storing instructions for facilitating creating an engagement advertisement by an advertiser, the instructions to cause a computing device to:
provide a plurality of design templates to an advertiser;
receive template information indicating selection by the advertiser of at least one of the plurality of design templates to use for creating an engagement advertisement, the selected template including a plurality of phases;
provide a graphical user interface to the advertiser to allow the advertiser to customize the selected template;
receive customization information indicating which of the plurality of phases will be a part of the engagement advertisement, content of each phase that will be a part of the engagement advertisement, and an order for presenting the phases; and
create the engagement advertisement according to the customization information received.

14. The computer readable medium of claim 13, the instructions further causing the computing device to:
receive information indicating interactions with the engagement advertisement that result in a user receiving remuneration for interacting with the advertisement.

15. The computer readable medium of claim 14, wherein the advertiser indicates that a user reaching a last phase of the engagement advertisement results in the user receiving remuneration.

16. The computer readable medium of claim 13, the instructions further causing the computing device to:
transmit the engagement advertisement to a user device for presentation to a user;
receive interaction information describing interactions by the user with the engagement advertisement; and
responsive to the interactions by the user constituting a remuneration event, determine to remunerate the user for the interactions with the engagement advertisement.

17. The computer readable medium of claim 16, the instructions further causing the computing device to:
notify a publishing system to remunerate the user, including an amount to remunerate the user, wherein the publishing system provided content to the user device that allowed the user to access the engagement advertisement.

18. The computer readable medium of claim 16, wherein the user chooses the remuneration from multiple options.

19. The computer readable medium of claim 13, the instructions further causing the computing device to receive information from the advertiser defining interactions that are to be completed by a user to complete a phase of the engagement advertisement.

20. The computer readable medium of claim 13, wherein the selected design template includes a framework for the engagement advertisement that allows for customization.

21. The computer readable medium of claim 20, wherein the framework describes an appearance of the engagement advertisement.

22. The computer readable medium of claim 20, wherein the framework describes phases of the selected template that are required to be a part of the engagement advertisement.

23. The computer readable medium of claim 13, the instructions further causing the computing device to receive targeting parameters for the engagement advertisement, the targeting parameters describing characteristics of a target audience for the engagement advertisement.

24. The computer readable medium of claim 13, the instructions further causing the computing device to receive payment parameters and schedule parameters for the engagement advertisement, the payment parameters describing pricing information for the advertisement and the schedule parameters describing a time period when the advertisement is active.
